(19) United States
(12) Patent Application Publication
(10) Pub. No.: US 2017/0126571 A1
(43) Pub. Date: May 4, 2017

(54) METHOD AND APPARATUS FOR CONTROLLING NETWORK BANDWIDTH

(71) Applicant: SAMSUNG SDS CO., LTD., Seoul (KR)

(72) Inventors: Ju Seok YUN, Seoul (KR); Jae Hong KIM, Seoul (KR); Young Gi KIM, Seoul (KR); Jun Youn JOO, Seoul (KR); Han Hwee CHO, Seoul (KR); Se Joong KIM, Seoul (KR)

(73) Assignee: SAMSUNG SDS CO., LTD., Seoul (KR)

(21) Appl. No.: 15/337,687

(22) Filed: Oct. 28, 2016

(30) Foreign Application Priority Data
Oct. 29, 2015 (KR) 10-2015-0151075

(51) Int. Cl. H04L 12/819

(52) U.S. Cl. CPC H04L 47/21; H04L 67/10

(57) ABSTRACT

A method of controlling network bandwidth, the method being performed by a server and comprising: receiving a transmission request for data from a client, calculating a delay time for controlling bandwidth of the client, receiving chunks of the data from the client at intervals of the delay time and restoring the data by merging the chunks.

A method of controlling network interface, the method being performed by a server and comprising: receiving a reception request for data from a client, calculating a delay time for controlling bandwidth of the client, and sending chunks of the data to the client at intervals of the delay time.

This application claims the benefit of Korean Patent Application No. 10-2015-0151075, filed on Oct. 29, 2015, in the Korean Intellectual Property Office, the disclosure of which is incorporated herein by reference in its entirety.

### BACKGROUND

1. Field

The present inventive concept relates to a method and apparatus for controlling network bandwidth, and more particularly, to a method of controlling a transmission rate of chunks in view of the priority of each piece of data when dividing data into chunks and sending the chunks through a network and an apparatus which performs the method.

2. Description of the Related Art

With the spread of Internet-based solutions such as cloud, network bandwidth is emerging as an issue. However, there is no proper solution to this issue.

In the conventional art, to send data through a network more efficiently, the data is divided into a number of chunks, and the chunks are sent. In some cases, the chunks may be sent in a parallel manner in multiple sessions instead of a single session.

However, due to the absence of an apparatus for controlling network bandwidth, there are cases where one client occupies the entire network bandwidth of a server and where data is sent using the same bandwidth regardless of the priority of data to be sent by each client. This often leads to thoughtless data uploading and downloading without bandwidth management, which results in frequent freezing or locking of a server solution.

There, of course, is a method of controlling network bandwidth using hardware. However, since the hardware is expensive equipment, restriction methods such as port restriction have to be used. In the case of access restriction, in particular, access control itself is difficult, and functions such as quality of service (QoS) cannot be provided.

In this regard, there is a need for a method of controlling network bandwidth using software, the method capable of efficiently solving the problem of network bandwidth in data transmission and securing the stability and reliability of data transmission through QoS management.

### SUMMARY

Aspects of the inventive concept provide a method and apparatus for controlling network bandwidth.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

In some embodiments, a method of controlling network bandwidth, the method being performed by a server and comprising: receiving a transmission request for data from a client, calculating a delay time for controlling bandwidth of the client, receiving chunks of the data from the client at intervals of the delay time, and restoring the data by merging the chunks.

In some embodiments, a method of controlling network interface, the method being performed by a server and comprising: receiving a reception request for data from a client; calculating a delay time for controlling bandwidth of the client, and sending chunks of the data to the client at intervals of the delay time.

In some embodiments, an apparatus for controlling network bandwidth, the apparatus comprising: a network interface, one or more processors, a memory which loads a computer program executed by the processors, and a storage device which stores throughput data and priority information, wherein the computer program executed by the apparatus for controlling network bandwidth comprises: an operation of receiving a transmission request for data from a client, an operation of calculating a delay time for controlling bandwidth of the client, an operation of receiving chunks of the data from the client at intervals of the delay time, and an operation of restoring the data by merging the chunks.

In some embodiments, an apparatus for controlling network bandwidth, the apparatus comprising: a network interface, one or more processors, a memory which loads a computer program executed by the processors, and a storage device which stores throughput data and priority information, wherein the computer program executed by the apparatus for controlling network bandwidth comprises: an operation of receiving a reception request for data from a client, an operation of calculating a delay time for controlling bandwidth of the client, and an operation of sending chunks of the data to the client at intervals of the delay time.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a conventional method of sending data without controlling network bandwidth;

FIG. 2 illustrates a method of controlling network bandwidth according to an embodiment;

FIG. 3 illustrates a method of controlling network bandwidth between each client according to an embodiment;

FIGS. 4A through 4F illustrate a delay time in a method of controlling network bandwidth according to an embodiment;

FIG. 5 illustrates a method of controlling network bandwidth in a case where a server has no available throughput according to an embodiment;

FIG. 6 is a conceptual diagram illustrating a method of controlling network bandwidth according to an embodiment;

FIG. 7 is a flowchart illustrating a method of controlling network bandwidth according to an embodiment;

FIG. 8 is a block diagram of an apparatus for controlling network bandwidth according to an embodiment; and

FIG. 9 illustrates the hardware configuration of an apparatus for controlling network bandwidth according to an embodiment.

### DETAILED DESCRIPTION

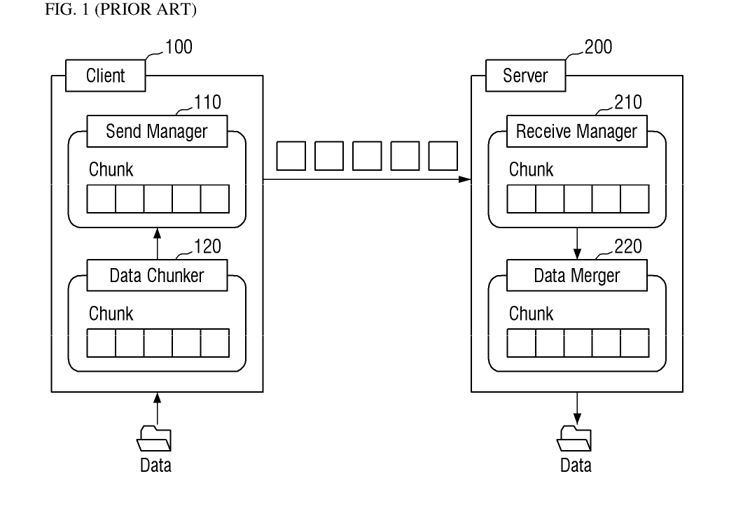

FIG. 1 illustrates a conventional method of sending data without controlling network bandwidth.

In FIG. 1, a process of sending data from a client 100 to a server 200 through a network is illustrated. The client 100 divides data to be sent into a number of chunks using a data chunker 120. In the process of dividing data into a number of chunks, the data chunker 120 may employ various algorithms. For example, the data chunker 120 may reduce the amount of data to be sent using data deduplication or may divide data into a number of chunks of the same size simply for parallel data processing. After data is divided into a number of chunks, a send manager 110 sequentially sends the chunks to the server 200. Then, a receive manager 210 of the server 200 receives the chunks sent from the send manager 110 of the client 100 and sends the received chunks to a data merger 220. The data merger 220 may restore the original data by merging the chunks. That is, the client 100 may divide data into a number of chunks and send the chunks to the server 200, and the server 200 may obtain the original file by merging the received chunks.

In the conventional art, there are no restrictions between the send manager 110 of the client 100 and the receive manager 210 of the server 200. Therefore, the receive manager 210 of the server 200 just has to receive chunks sent by the send manager 110 of the client 100. In this case, however, if a particular client 100 occupies the entire throughput of the server 200, other clients cannot access the server 200. In addition, since the particular client 100 occupies system resources of the server 200, there are cases where a solution of the server 200 stops. Furthermore, network bandwidth of the server 200 is equally shared by clients 100 regardless of a difference in the importance of the clients 100.

This is because data is sent without regard to the fact that the importance of each client 100 can vary according to the type or size of data to be sent by the client or according to various standards.

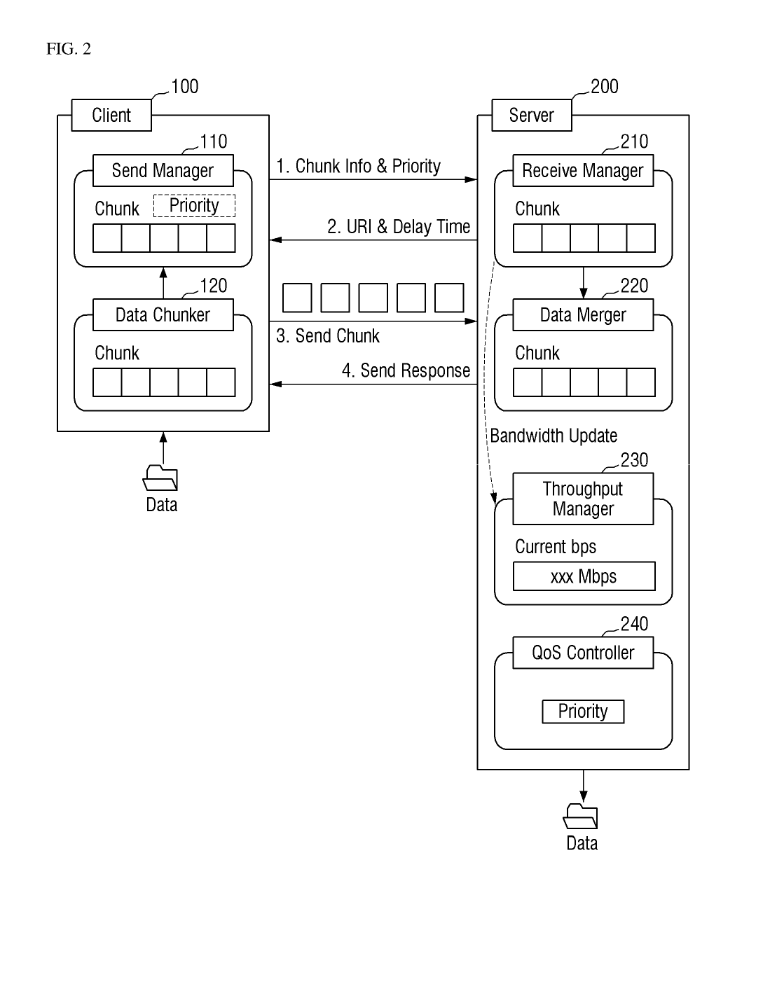

FIG. 2 illustrates a method of controlling network bandwidth according to an embodiment.

Referring to FIG. 2, a client 100 additionally includes priority, and a server 200 additionally includes a throughput manager 230 and a quality of service (QoS) controller 240. The throughput manager 230 is linked to the receive manager 210 to measure a transmission rate of each client 100 and store the measured transmission rate. Therefore, if the maximum throughput of the server 200 is 10 Mbps, the throughput manager 230 may manage the sum of the transmission rates of the clients 100 under 10 Mbps. To this end, the QoS controller 240 allocates the throughput of the server 200 to each client 100 according to priority.

The process of allocating the throughput of the server 200 to each client 100 may be implemented by setting a delay time between chunks of data sent by each client 100. That is, when sending a number of chunks to the server 200, a client 100 may be controlled to wait for a delay time set by the server 200 after sending a chunk and before sending a next chunk. In this case, it is possible to prevent a particular client 100 from occupying the entire throughput of the server 200. In addition, if a different delay time is set according to priority, a different throughput value can be set for each client 100. Therefore, more important data can be sent first.

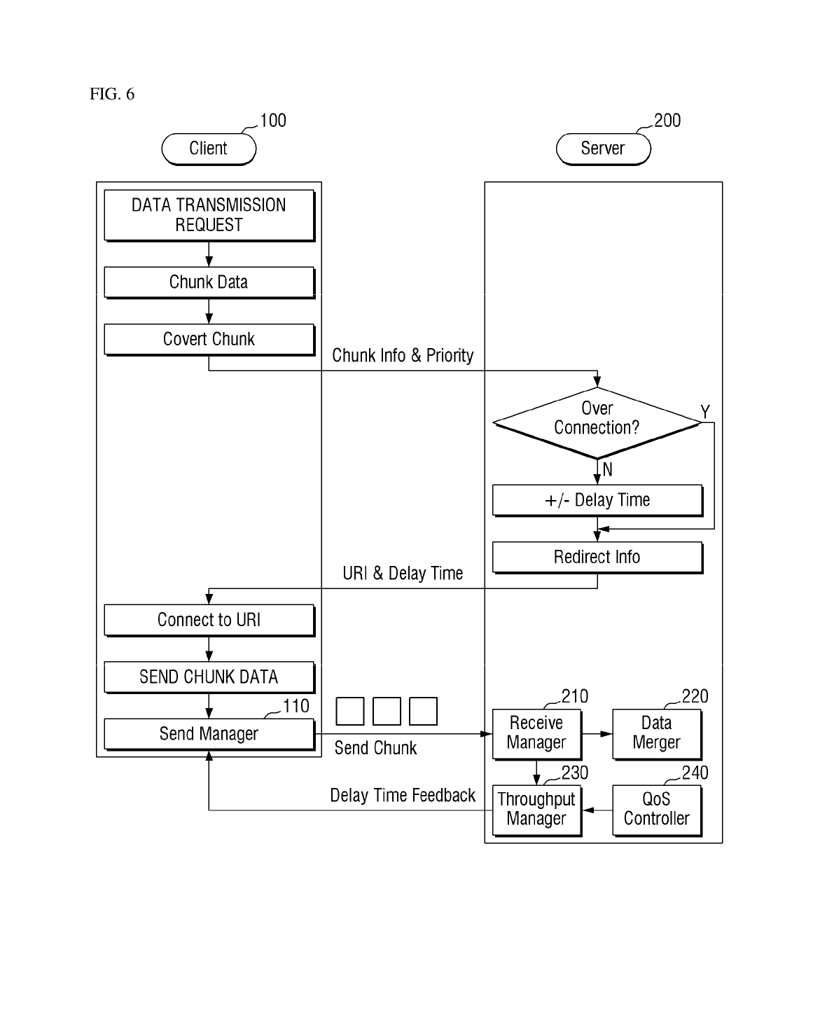

To this end, in the method of controlling network bandwidth according to the embodiment, a client 100 first sends information about chunks to be sent and priority to the server 200 (operation 1), unlike in the conventional art in which the client 100 sends the chunks directly to the server 200. The server 200 receives the chunk information and the priority and sends to the client 100 a uniform resource identifier (URI) to which the chunks can be sent and a delay time which is to be used when the chunks are sent using the QoS controller 240 (operation 2). In addition, the server 200 stores the priority received from the client 100 in the QoS controller 240. This is to compare the priority of the client 100 with that of another client 100 when the another client 100 makes a data transmission request. The URI and the delay time will be described in greater detail later with reference to FIG. 6. The client 100 receives the URI and the delay time from the server 200 and sends the chunks to the server 200 at regular intervals according to the delay time set by the server 200 (operation 3). The server 200 receives the chunks from the client 100 and sends the received chunks to a data merger 220. Then, the data merger 220 restores the original data using the chunks. In addition, the server 200 may send a response indicating the completion of reception of the chunks to the client 100 (operation 4). The responses that can be sent by the server 200 to the client 100 may include a reception completion response and a response requesting the client 100 to resend a chunk if the chunk is defective. Generally, the reception completion response is referred to as an acknowledgement (ACK) response, and the abnormal reception response is referred to as an ASK response.

As illustrated in FIG. 2, the server 200 can manage the throughput of a client 100 by setting the delay time of the client 100 based on chunk information and priority that the client 100 sent before sending chunks. Therefore, it is possible to prevent a particular client from occupying the entire throughput of the server 200. In a case where there are a plurality of clients, a different delay time may be for each of the clients as follows.

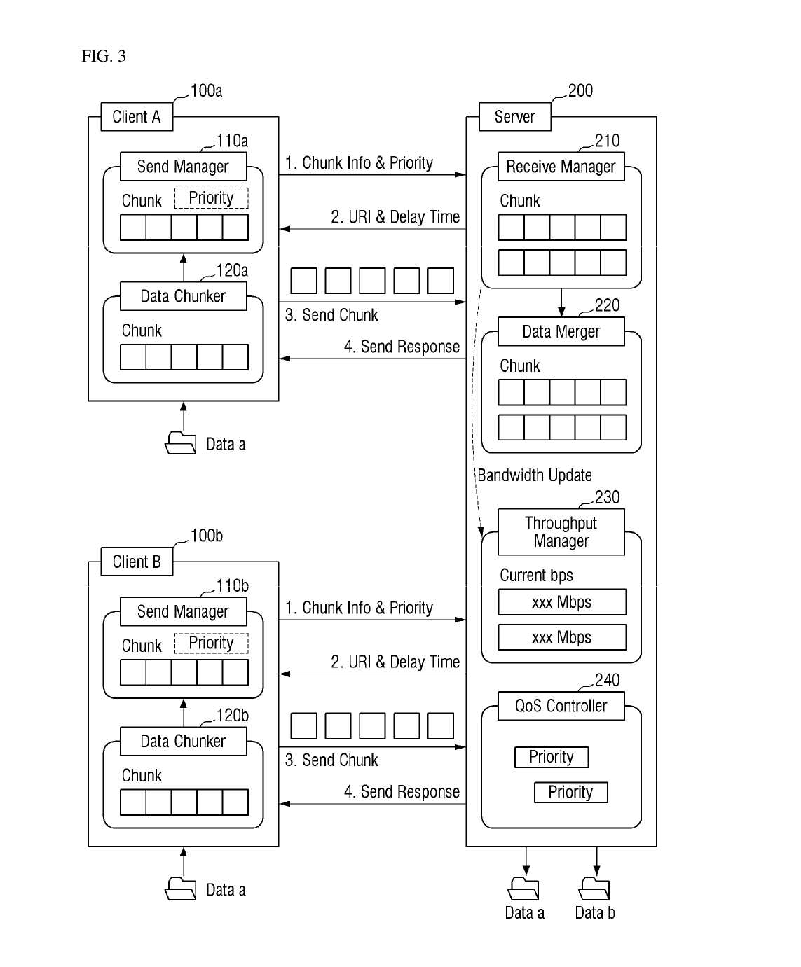

FIG. 3 illustrates a method of controlling network bandwidth between each client according to an embodiment.

In FIG. 3, unlike in FIG. 2, a plurality of clients, that is, client A 100a and client B 100b are connected to a server 200. Even in this case, the basic data transmission process is not much different from FIG. 2. However, a QoS controller 240 of the server 200 sets a different delay time for each client 100a or 100b according to priority sent by the client 100a or 100b and sends the delay time to the client 100a or 100b so that the client 100a or 100b has different throughput. In addition, the server 200 may not only send the delay time to each client 100a or 100b in response to chunk information and priority that the client 100a or 100b sent as advance information before sending chunks, but a throughput manager 230 of the server 200 may also measure a data transmission rate of each client 100a or 100b in real time, and the QoS controller 240 may change the delay time in real time based on the measured data transmission rate and send the changed delay time to the client 100a or 100b.

That is, the delay time is a value that is not only set in an initial process of generating a connection but also continuously changed in real time even while the client 100a or 100b is sending chunks to the server 200. Therefore, the throughput manager 230 of the server 200 measures and updates the transmission rate of each client 100a or 100b in real time, and the QoS controller 240 identifies whether the throughput of the server 200 has been properly allocated to each client 100a or 100b according to priority so that each client 100a or 100b can have an appropriate transmission rate and then feeds the adjusted delay time back to each client 100a or 100b in real time. If the actual transmission rate of each client 100a or 100b is smaller than the throughput allocated to the client 100a or 100b, the QoS controller 240 may change the delay time allocated to the client 100a or 100b in the initial process of generating a connection to a shorter delay time and feed the shorter delay time back to the client 100a or 100b as a new set value. On the contrary, if the actual transmission rate of each client 100a or 100b is greater than the throughput allocated to the client 100a or 100b, the QoS controller 240 may feed a delay time longer than the delay time allocated to the client 100a or 100b in the initial process of generating a connection back to the client 100a or 100b as a new set value.

Setting a delay time in view of the priority of each client 100a or 100b and changing the delay time in view of the actual transmission rate of each client 100a or 100b has been described above. Hereinafter, factors that can be taken into consideration when the server 200 actually allocates its throughput to each client 100a or 100b will be described. First of all, the maximum throughput of the server 200 may be one criterion that determines the delay time. In addition, the number of clients 100 currently connected to the server 200 may be one factor that determines the delay time of each client 100. The delay time may also vary according to data priority sent by the client 100 in the initial process of generating a connection.

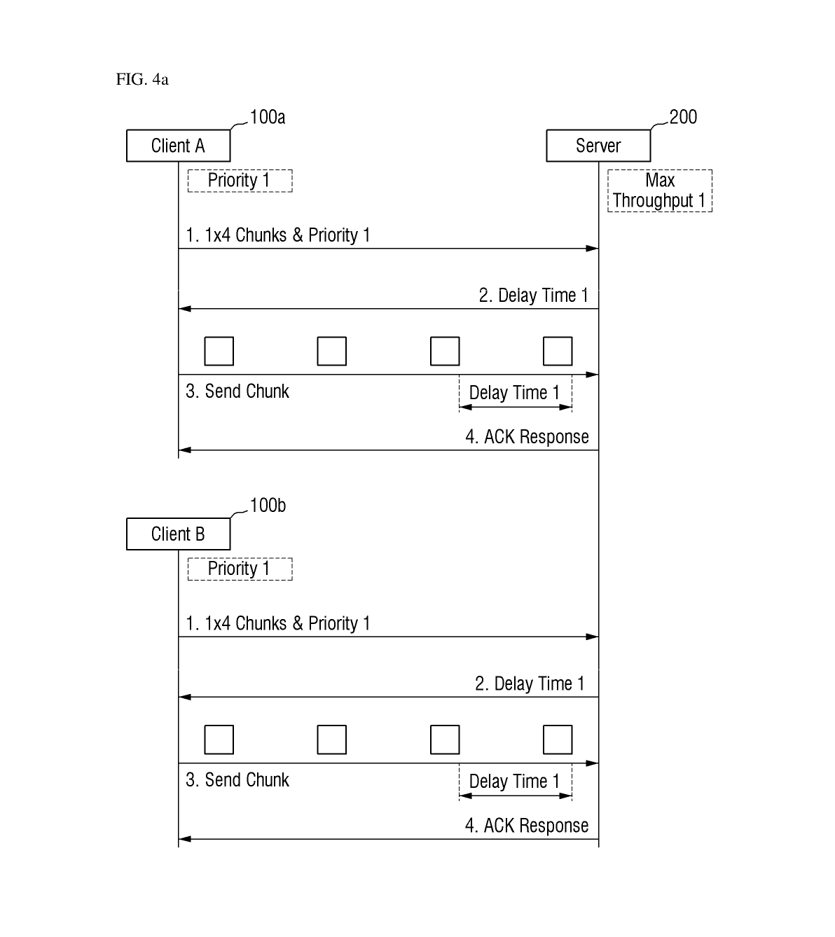

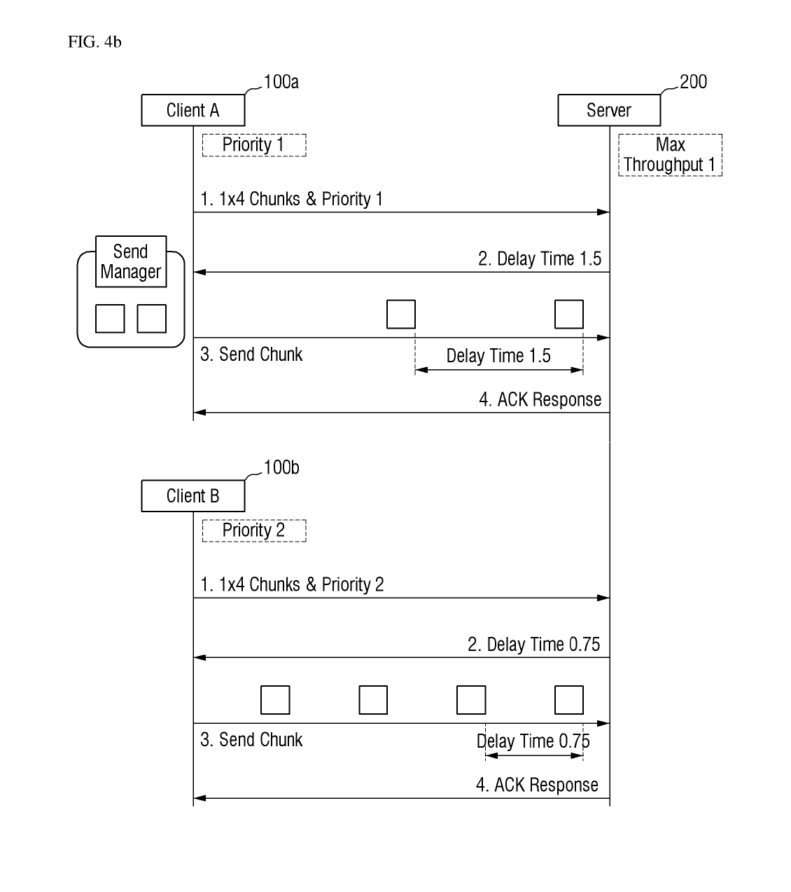

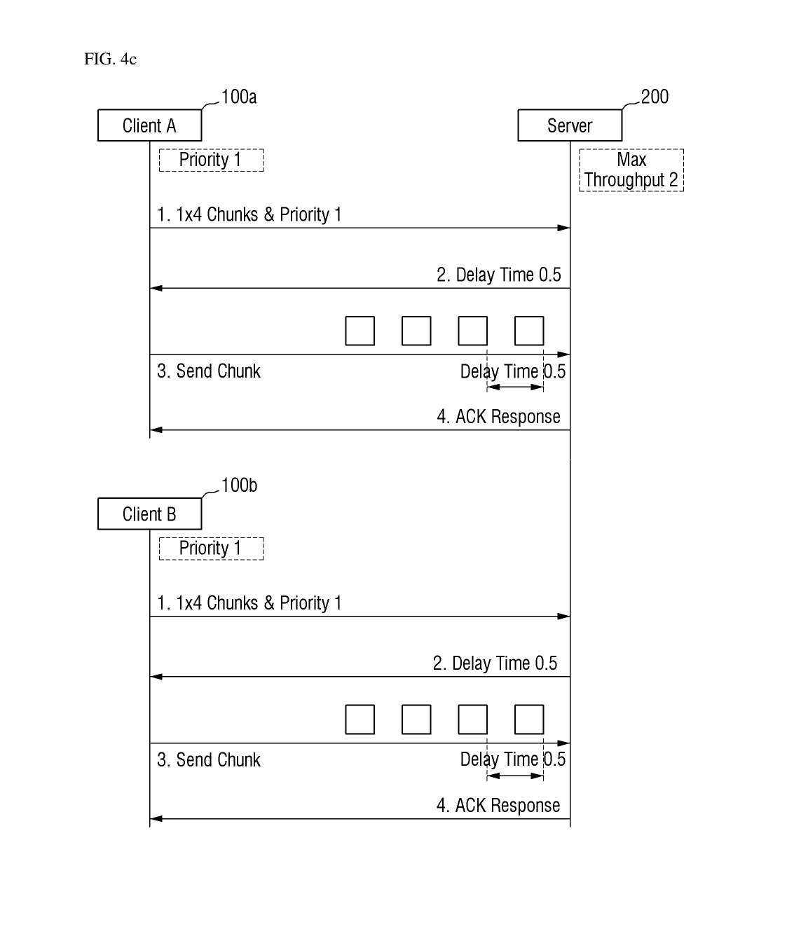

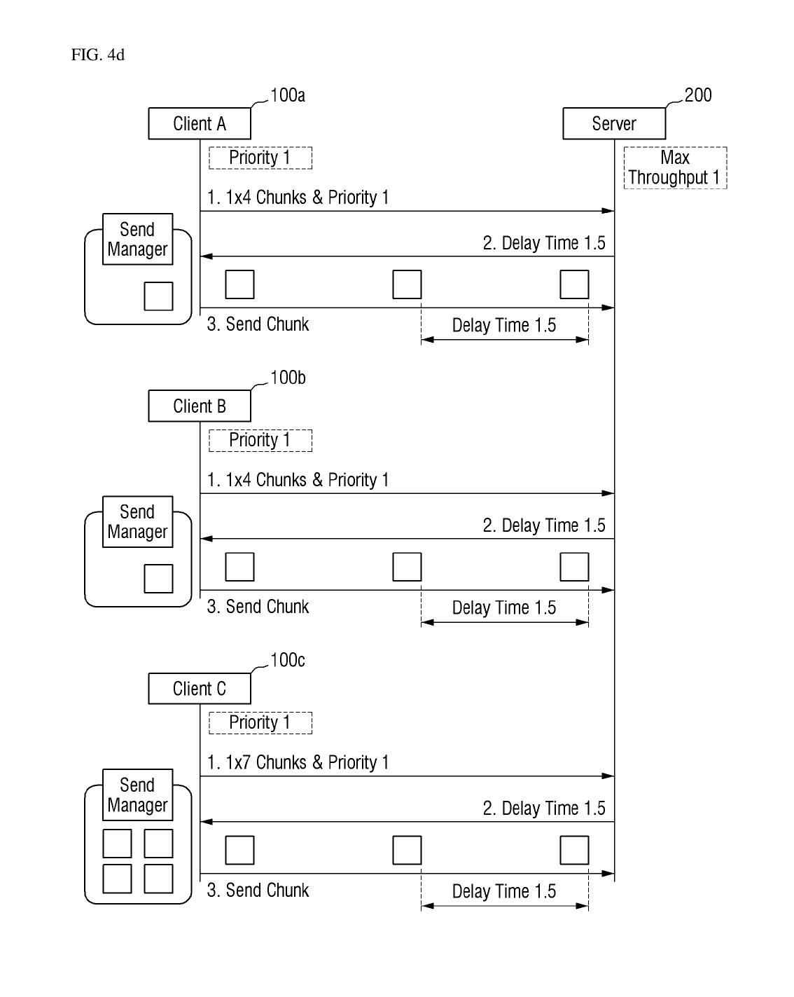

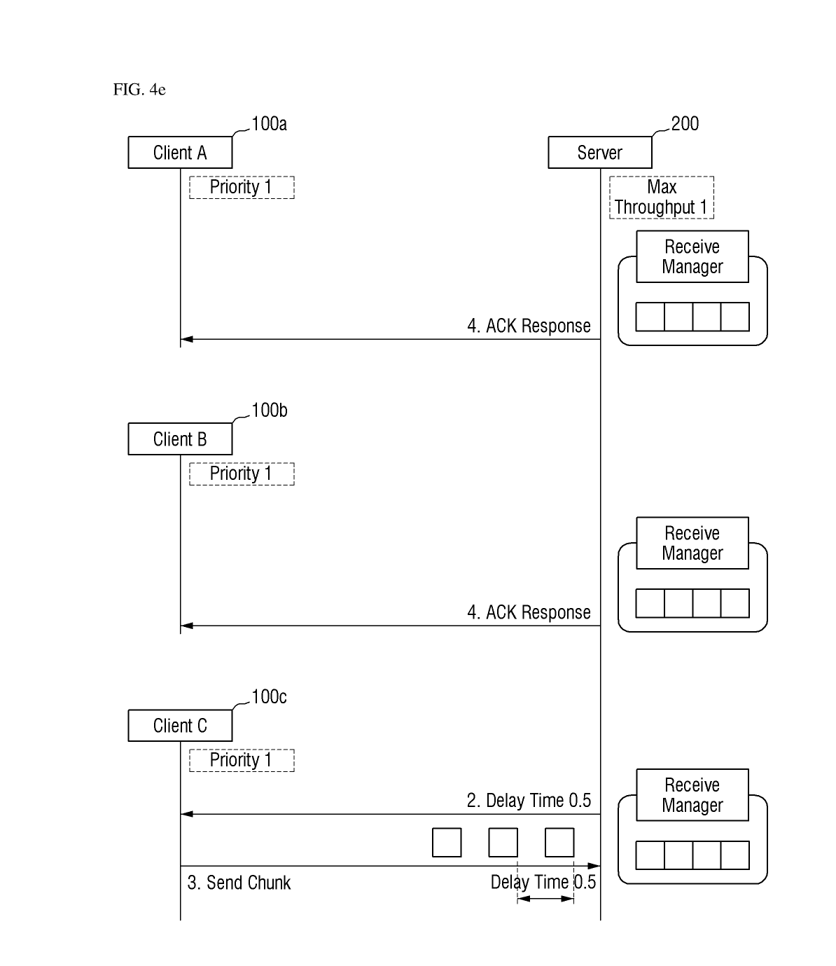

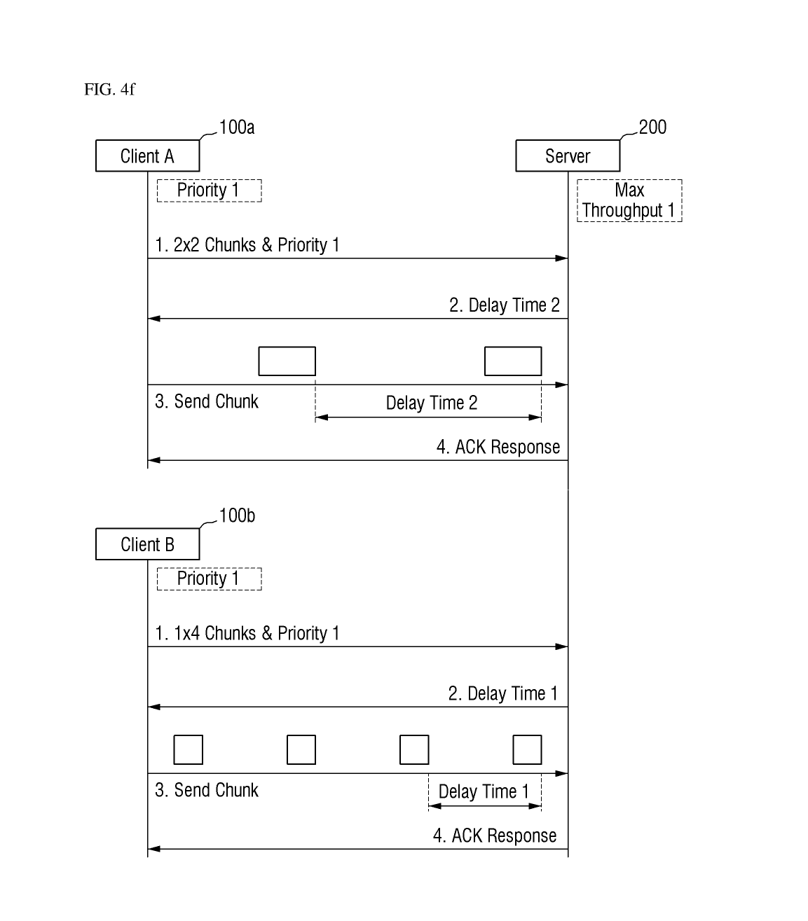

FIGS. 4A through 4F illustrate a delay time in a method of controlling network bandwidth according to an embodiment.

Referring to FIG. 4A, a process in which client A 100a having a priority of 1 and client B 100b also having a priority of 1 send data to a server 200 having a maximum throughput of 1 is illustrated. Data to be sent by client A 100a is composed of four chunks of a unit size of 1. Likewise, data to be sent by client B 100b is composed of four chunks of a unit size of 1. First, client A 100a and client B 100b send chunk information and priority information to the server 200 as data transmission requests (operation 1). In response to the data transmission requests from client A 100a and client B 100b, the server 200 calculates a delay time of each client 100a or 100b and sends the calculated delay time to client A 100a or client B 100b (operation 2). In the example of FIG. 4A, client A 100a and client B 100b have the same conditions. Therefore, a unit time of 1 is set for both client A 100a and client B 100b as a delay time. Each of client A 100a and client B 100b notified of the delay time by the server 200 controls its throughput by waiting for the delay time after sending one chunk and before sending a next chunk (operation 3). After the chunks are completely sent by each of client A 100a and client B 100b, the server 200 sends an ACK response to each client 100a or 100b (operation 4). Since the two clients 100a and 100b have the same priority, the server 200 receives data by allocating its throughput equally to the clients 100a and 100b within its maximum throughput. Therefore, it is possible to prevent any one client from occupying the entire throughput of the server 200 in the example of FIG. 4A.

Referring to FIG. 4B, unlike in the example of FIG. 4A, client B 100b has a priority of 2 which is higher than the priority of client A 100a. Other conditions are the same as in FIG. 4A, except for the priority of client B 100b. In this case, it is necessary to reduce the throughput of client A 100a and increase the throughput of client B 100b a little. It will hereinafter be assumed that a higher priority value indicates higher priority and greater importance. Since the priority of client B 100b is higher than that of client A 100a, the throughput of the server 100 should be allocated a little more to client B 100b. To this end, unlike in the example of FIG. 4A, different delay times should be set for client A 100a and client B 100b. In this case, since client A 100a has a priority of 1 and client B 100b has a priority of 2, a unit time of 1.5 may be set as a delay time of client A 100a, and a unit time of 0.75 may be set as a delay time of client B 100b. Accordingly, the throughput of client B 100b may be set to be twice the throughput of client A 100a. This is because throughput (i.e., transmission rate) is a value inversely proportional to the delay time. In other words, as the priority of a client increases, the delay time of the client should be set to a smaller value. Until now, of factors that can affect the delay time, priority has been described with reference to FIG. 4B.

Referring to FIG. 4C, unlike in the example of FIG. 4A, the maximum throughput of the server 200 has doubled to 2. Other conditions are the same as in the example of FIG. 4A, except for the maximum throughput of the server 200. Since the maximum throughput of the server 200 has doubled in the example of FIG. 4C as compared with the example of FIG. 4A, the throughput that can be allocated to each client 100a or 100b may also double. On the contrary, a delay time set for each client 100a or 100b is reduced to half. That is, in FIG. 4A, the delay time of each client 100a or 100b is a unit time of 1 under the same conditions. However, in FIG. 4C, the delay time of each client 100a or 100b is changed to a unit time of 0.5 under the same conditions except for the maximum throughput of the server 200. In other words, even if each client 100a or 100b sends chunks twice faster than in the example of FIG. 4A, the server 200 can process the chunks. Therefore, the maximum throughput of the server 200 can be utilized efficiently. As the maximum throughput of the server 200 increases, the delay time decreases in inverse proportion to the maximum throughput. This is because the server 200 can receive and process more chunks at a time. Until now, of the factors that can affect the delay time, the maximum throughput of the server 200 has been described with reference to FIG. 4C.

Referring to FIG. 4D, unlike in the example of FIG. 4A, client C 100c has been added. Client C 100c has the same priority of 1 as client A 100a and client B 100b. However, client C 100c is different from client A 100a and client B 100b in that it intends to send seven chunks of a unit size of 1. While the maximum throughput of the server 200 has been shared by two clients 100a and 100b, it should now be shared by three clients 100a through 100c as a result of the addition of client C 100c. Therefore, the clients 100a through 100c may have the same delay time, but the delay time for the clients 100a through 100c may be set to a value greater than the value in FIG. 4A. The QoS controller 240 of the server 200 may calculate the delay time and set the delay time of each client 100a, 100b or 100c to a unit time of 1.5. Accordingly, even if a new client 100c is added while the existing clients 100a and 100b already connected to the server 200 are sending data to the server 200, the delay times of the connected clients 100a and 100b can be increased, and the throughput of the server 200 which is secured by increasing the delay times of the connected clients 100a and 100b can be allocated to the newly connected client 100c. Until now, the number of clients 100 connected to the server 200 has been described with reference to FIG. 4D as a factor that can affect the delay time. In the case of a single session based on which the inventive concept has been described above, the delay time is calculated in view of the number of clients 100. However, the delay time should be calculated based on the number of sessions connected to the server 200 in the case of parallel connection such as multiple sessions. In this case, other conditions are the same except that the standard is changed from the number of clients 100 to the number of sessions. Returning to the case of a single session, as the number of clients 100 connected to the server 200 increases, the throughput of the server 200 which is allocated to each client 100 is reduced, and a longer delay time is set for each client 100. That is, the larger the number of clients 100, the longer the delay time.

Referring to FIG. 4E, in the case of FIG. 4D, client C 100c has three more chunks to send than client A 100a and client B 100b. Therefore, the situation after client A 100a and client B 100b complete chunk transmission will now be described. After receiving all four chunks from each of client A 100a and client B 100b, the server 200 restores the original data. Here, the server 200 may send an ACK response (i.e., a reception completion response) to each of client A 100a and client B 100b. After receiving the ACK response from the server 200, client A 100a and client B 100b terminate their connection to the server 200 because they have no more chunks to send. Then, only client C 100c remains connected to the server 200. Therefore, client C 100c can monopolize the throughput of the server 100 which was shared with client A 100a and client B 100b. That is, client C 100c had a delay time of 1.5 when sending four chunks, but the delay time of client C 100c may be updated after client A 100a and client B 100b complete chunk transmission. The server 200 may reduce the delay time of client C 100 from a unit time of 1.5 to a unit time of 0.5 so that client C 100c can use the throughput previously used by client A 100a and client B 100b. That is, since the number of clients 100 connected to the server 200 which can affect the delay time is a value that can be changed every moment, the QoS controller 240 of the server 200 may calculate the delay time of each client 100 in real time and update the delay time to a new delay time. Accordingly, the throughput of the server 200 can be shared efficiently regardless of whether the number of clients 100 connected to the server 200 is large or small. Until now, of the factors that can affect the delay time, the number of clients 100 connected to the server 200 has been described with reference to FIGS. 4D and 4E.

Referring to FIG. 4F, the size of chunks to be sent by client A 100a has doubled compared with the example of FIG. 4A. That is, while four chunks of a unit size of 1 are sent in the example of FIG. 4A, two chunks of a unit size of 2 are sent in the example of FIG. 4F. In most cases, chunks have the same size regardless of client 100. However, in some cases, the size of chunks to be sent may vary according to client 100. In these cases, the delay time should be calculated in view of the chunk size as well. If a unit time of 1 is set for client A 100a as a delay time as in the example of FIG. 4A, a chunk of a unit size of 2 is sent for a unit time of 1. Therefore, only when the delay time is doubled, can the original throughput allocated to client A 100a be secured. In the case of FIG. 4F, a unit time of 2 which is twice the unit time of 1 in FIG. 4A is set for client A 100a as a delay time. Accordingly, two chunks of a unit size of 2 are sent for a unit time of 4. Therefore, client A 100a can secure the same throughput as the throughput of client B 100b which sends four chunks of a unit size of 1 for a unit time of 4. Until now, of the factors that can affect the delay time, the size of chunks to be sent by a client 100 has been described with reference to FIG. 4F.

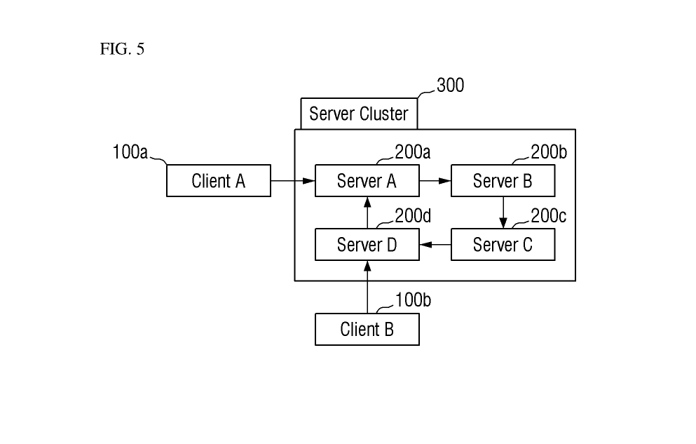

FIG. 5 illustrates a method of controlling network bandwidth in a case where a server has no available throughput according to an embodiment.

The method of controlling network bandwidth by setting the delay time of each client 100 has been described above with reference to FIGS. 4A through 4F. However, even if a server 200 controls network bandwidth, there may be cases where the server 200 cannot process data anymore. In this situation, if the server 200 receives a data transmission request from a client 100, it may deal with the data transmission request as in FIG. 5. Referring to FIG. 5, server A 200a, server B 200b, server C 200c and server D 200d form one server cluster 300. In a situation where server A 200a can process no more requests from clients 100 because it is currently using all its network bandwidth, it may receive a transmission request from client A 100a.

In this case, since server A 200a cannot process the request of client A 100a, it may send the request of client A 100a to server B 200b, server C 200c or server D 200d which can process the request. It would be good if server A 200a knew which of server B 200b, server C 200c and server D 200d had the most available throughput and sent the request to the server with the most available throughput. However, even if server A 200a does not know, if the servers are connected in a circulation structure, it would good enough for server A 200a to send the request of client A 100a to a next server, i.e., server B 200b. If server B 200b also cannot process the request of client A 100a, it may just send the request of client A 100a to server C 200c. Likewise, if server C 200c cannot process the request of client A 100a, it may also send the request of client A 100a to server D 200d.

When the servers that form the server cluster 300 are connected in the circulation structure, even if each server does not know the throughput state of other servers, it can find a server which can process a request of a client simply by sending the request to its next server. That is, if the number of servers is n, a server which can process a request of a client can be found after the request is sent (n−1) times in the worst-case scenario. Therefore, when receiving a transmission request from a client 100, each server 200 may identify whether it can process the request of the client 100 before calculating a delay time. When the server 200 cannot process the request, it may send the request of the client 100 to another server. When the server 200 can process the request, it may calculate the throughput to be allocated to the client 100 and a delay time corresponding to the throughput and send an URI and the delay time to the client 100 as a response to the transmission request. This enables load balancing between the servers that form the server cluster 300.

FIG. 6 is a conceptual diagram illustrating a method of controlling network bandwidth according to an embodiment.

In FIG. 6, a data transmission flow between a client 100 and a server 200 can be seen at a glance. For data transmission, the client 100 divides data to be sent into a number of chunks and sends information about the chunks and priority to the server 200 as a data transmission request. Here, the information about the chunks consists mainly of the size and number of the chunks. The server 200 receives the data transmission request of the client 100 and identifies whether the number of clients connected to the server 200 has reached a limit. If the number of clients connected to the server 200 has reached the limit, the server 200 cannot process the data transmission request of the client 100. Therefore, the server 200 sends an URI of another server to the client 100. On the other hand, if the server 200 can process the data transmission request of the client 100, it calculates a delay time to be sent to the client 100. Factors that can affect the delay time include priority, the maximum throughput of the server 200, the number of clients 100 connected to the server 200, the size of chunks to be sent, etc., as described above with reference to FIGS. 4A through 4F. By taking these factors into consideration, the server 200 sends the delay time to the client 100.

If the server 200 sends the URI of another server to the client 100, the client 100 should attempt to connect to the server and send a transmission request to the server. On the other hand, if the server 200 sends its URI and a delay time to the client 100, a send manager 110 of the client 100 sequentially sends chunks to the server 200 according to the delay time set by the server 200. Then, a receive manager 210 of the server 200 receives the chunks from the client 100 and sends the received chunks to a data merger 200 to restore the original data from the chunks. The server 200 measures a chunk transmission rate of the client 100 in real time and manages the chunk transmission rate using a throughput manager 230. A QoS controller 240 of the server 200 calculates the delay time of the client 100 by reflecting, in real time, the transmission rate of the client 100 managed by the throughput manager 230 and feeds the delay time back to the client 100. If conditions have been changed after the delay time was calculated in the initial process of generating a connection or if the actual throughput of the client 100 is large or small compared with the initially calculated delay time, the delay time is corrected. In so doing, the throughput of the server 200 can be utilized efficiently within the maximum throughput of the server 200.

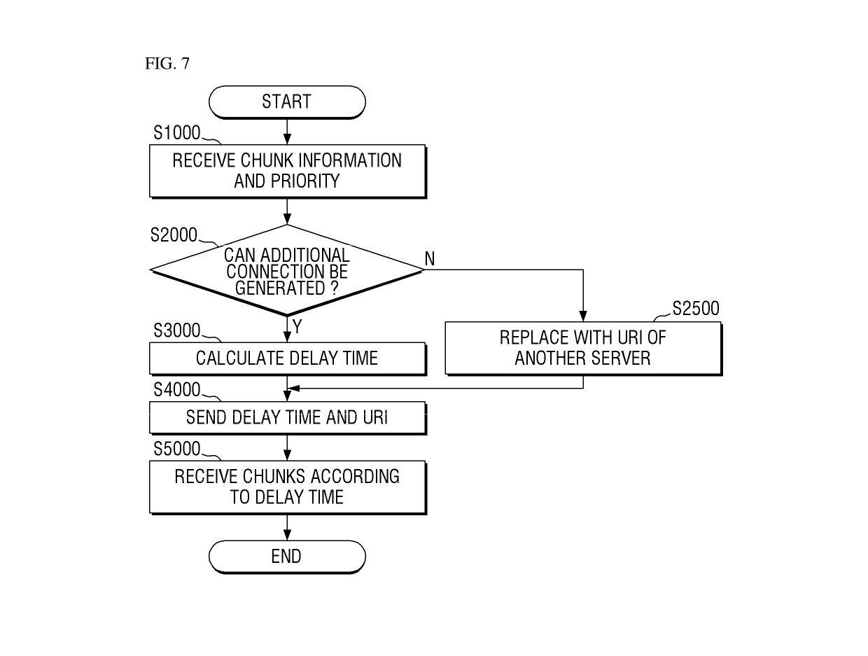

FIG. 7 is a flowchart illustrating a method of controlling network bandwidth according to an embodiment.

Referring to FIG. 7, a sever 200 receives, as a data transmission request, information about chunks to be sent and priority from a client 100 which intends to send data (operation S1000). As described above, the information about the chunks may include the size and number of the chunks to be sent. The server 200 receives the data transmission request from the client 100 and identifies whether it can process the data transmission request of the client 100 by generating an additional connection based on its data processing situation (operation S2000). If the server 200 cannot process the data transmission request of the client 100, it replaces its URI with a URI of another server 200 (operation 52500) and sends the URI of the another server 200 to the client 100 (operation S4000). When the client 100 receives the URI of the another server 200 instead of the URI of the server 200 to which the client 100 sent the data transmission request, it sends the data transmission request to the another server 200 and proceeds with data transmission according to the situation of the another server 200.

If the server 200 can process the data transmission request of the client 100 by generating an additional connection, it calculates a delay time to be used when the client 100 sends the data (operation S3000). As for factors that affect the delay time, the delay time of the client 100 is set to a smaller value as the priority of the client 100 is higher. In addition, the delay time is set to a smaller value as the maximum throughput of the server 200 is greater. The delay time is set to a larger value as the number of clients 100 connected to the server 2000 is larger. The delay time is set to a larger value as the size of chunks to be sent by the client 100 is larger. Through this process, a QoS controller 240 calculates the delay time in view of the priority sent by each client 100 together with the data transmission request (operation S3000) and sends the calculated delay time to the client 100 (operation S4000). The client 100 sequentially sends the chunks to the server 200 according to the delay time set by the server 200, and the server 200 sequentially receives the chunks from the client 100 according to the delay time (operation S5000). In this way, the network bandwidth for the data transmission request of each client 100 can be controlled efficiently according to priority within the maximum throughput of the server 200.

In addition, when the factors that can affect the delay time are changed while the server 200 is actually receiving chunks from each client 100, the server 200 may calculate a new delay time and feed the new delay time back to each client 100. Of the factors that can affect the delay time, the priority of each client 100, the maximum throughput of the server 200, and the size of chunks to be sent by each client 100 may be invariable, but the number of clients 100 connected to the server 200 may be variable. Therefore, the throughput of each client 100 may be controlled according to a change in the number of clients 100 connected to the server 200 by changing the delay time in real time in view of the variable number of clients 100 connected to the server 200.

In addition to the above-described factors, there are various factors that can actually affect the throughput of each client 100. If the above-described factors are controllable factors that can be taken into consideration in the calculation of the delay time, there may also be uncontrollable factors that can affect the throughput of each client 100. For example, various factors such as the network state between each client 100 and the server 200 and the difference in the performance of the clients 100 can affect the throughput of each client 100. To reduce the effect of these factors on the throughput of each client 100, the QoS controller 240 of the server 200 may correct the delay time based on a real-time transmission rate of each client 100 managed by a throughput manager 230 of the server 200. If the actual transmission rate of a client 100 is smaller than the throughput allocated to the client 100, a delay time shorter than a delay time allocated to the client 100 during initial connection setting may be fed back to the client 100 as a new set value. On the contrary, if the actual transmission rate of the client 100 is greater than the throughput allocated to the client 100, a delay time longer than the delay time allocated to the client 100 during the initial connection setting may be fed back to the client 100 as a new set value.

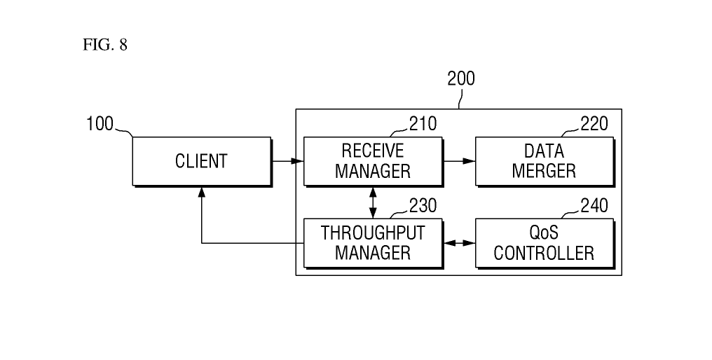

FIG. 8 is a block diagram of an apparatus 200 for controlling network bandwidth according to an embodiment.

Referring to FIG. 8, the apparatus 200 for controlling network bandwidth may include a receive manager 210, a data merger 220, a throughput manager 230, and a QoS controller 240. The receive manager 210 may receive a data transmission request and chunks from a client 100. The receive manager 210 may send the data transmission request of the client 100 to the QoS controller 240 and request the QoS controller 240 to determine whether to accept the data transmission request of the client 100 and, if determining to accept the data transmission request of the client 100, calculate a delay time to be used by the client 100. In addition, the receive manager 210 may send the chunks received from the client 100 to the data merger 220 to restore the original data from the chunks.

The data merger 220 receives the chunks of the data from the receive manager 210. Although not described in the data transmission process due to its too small size, meta information of each chunk of the data may also be received. Then, the data merger 220 may identify how the chunks should be merged to obtain the original data and restore the data by merging the chunks.

The throughput manager 230 is linked in real time to the receive manager 210 to measure a transmission rate when the server 200 receives the chunks from the client 100. The throughput manager 230 may provide the measured transmission rate to the QoS controller 240 so that the QoS controller 240 can correct the delay time by a difference between the measured transmission rate and the throughput actually allocated to the client 100.

When generating an initial connection to the client 100, the QoS controller 240 may determine whether to generate a connection and calculate a delay time to be used by the client 100. In addition, when factors that affect the delay time are changed, the QoS controller 240 may calculate the delay time in real time and feed the delay time back to the client 100. Furthermore, when the real-time throughput of each client 100 which is measured by the throughput manager 230 is different from the throughput intended to be actually allocated to each client 100 through delay time setting, the QoS controller 240 may correct the delay time to reduce the difference and feed the corrected delay time back to the client 100.

Until now, a case where data is uploaded from a client 100 to a server 200 has mainly been described. However, controlling network bandwidth using a delay time can also be applied to a case where data is downloaded from the client 100 to the server 200. That is, the server 200 may receive a download request from the client 100 together with priority and divide data into a number of chunks in order to send the data to the client 100. Then, the QoS controller 240 may calculate a delay time of the client 100 and sequentially send the chunks to the client 100 according to the delay time. The only differences from the former case are that there is no need to inform the client 100 of the delay time because it is the server 200 that sends the chunks and that the server 200 can immediately update the delay time for sending data to the client 100 according to situation. Except for these differences, basic characteristics of controlling network bandwidth using a delay time are the same in the above two cases.

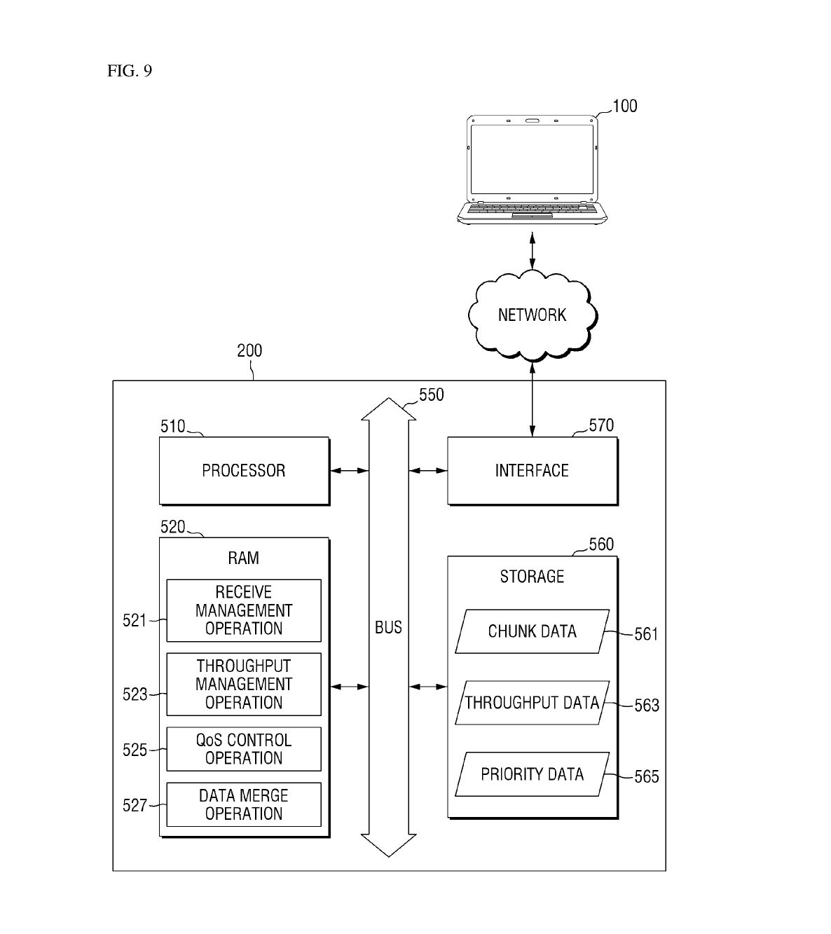

FIG. 9 illustrates the hardware configuration of an apparatus 200 for controlling network bandwidth according to an embodiment.

Referring to FIG. 9, the apparatus 200 for controlling network bandwidth may include one or more processors 510, a memory 520, a storage device 560, and a network interface 570. The processors 510, the memory 520, the storage device 560, and the network interface 570 may exchange data with each other through a system bus 550.

The processors 510 execute a computer program loaded in the memory 520, and the memory 520 loads the computer program from the storage device 560. The computer program may include a receive management operation 521, a throughput management operation 523, a QoS control operation 525, and a chunk merge operation 527.

The receive management operation 521 may receive a data transmission request and chunks from a client 100 through a network. The receive management operation 521 may send the data transmission request of the client 100 to the QoS control operation 525 and request the QoS control operation 525 to determine whether to accept the data transmission request and, if determining to accept the data transmission request, calculate a delay time to be used by the client 100. Here, the receive management operation 521 may store priority information 565 received from the client 100 in the storage device 560 through the system bus 550. The stored priority information 565 may be used when the QoS control operation 525 calculates the delay time of each client 100. In addition, chunk data 561 received from the client 100 by the receive management operation 521 may be stored in the storage device 560 through the system bus 550. The receive management operation 521 may send the chunks stored as the chunk data 561 in the storage device 560 to the data merge operation 527 to restore the original data from the chunks.

The throughput management operation 523 may be linked in real time to the receive management operation 521 to measure a transmission rate when the server 200 receives the chunks from the client 100. Then, the throughput management operation 523 may store the measured transmission rate as throughput data 563 in the storage device 560 through the system bus 550. The throughput management operation 523 may provide the stored throughput data 563 to the QoS control operation 525 so that the QoS control operation 525 can correct the delay time by a difference between the measured transmission rate and the throughput actually allocated to the client 100.

When generating an initial connection to the client 100, the QoS control operation 525 may determine whether to generate a connection and calculate a delay time to be used by the client 100. In addition, when factors that affect the delay time are changed, the QoS control operation 525 may calculate the delay time in real time and feed the delay time back to the client 100. Furthermore, when the real-time throughput of each client 100 which is measured by the throughput management operation 570 is different from the throughput intended to be actually allocated to each client 100 through delay time setting, the QoS control operation 525 may correct the delay time to reduce the difference and feed the corrected delay time back to the client 100.

The data merge operation 527 receives the chunk data 561 stored in the storage device 560 from the receive management operation 521 through the system bus 550. Although not described in the data transmission process due to its too small size, meta information of each chunk of the data may also be received. Then, the data merge operation 527 may identify how the chunks should be merged to obtain the original data and restore the data by merging the chunks.

According to the inventive concept described above, a session terminal measures the real-time bandwidth of all data being sent and controls the bandwidth of each session in real time based on the measured real-time bandwidth, thereby preventing a particular session from monopolizing network bandwidth.

In addition, QoS is applied to data by managing the bandwidth of both a server and a client. Therefore, data can be sent efficiently according to priority.

What is claimed is:

1. A method of controlling network bandwidth, the method being performed by a server and comprising:
receiving a transmission request for data from a client;
calculating a delay time for controlling bandwidth of the client;
receiving chunks of the data from the client at intervals of the delay time; and
restoring the data by merging the chunks.

2. The method of claim 1, wherein the receiving of the transmission request for the data comprises further receiving priority of the data from the client.

3. The method of claim 1, wherein the receiving of the transmission request for the data comprises further receiving the size and number of the chunks from the client.

4. The method of claim 1, wherein the receiving of the transmission request for the data comprises, when the server cannot process the data transmission request of the client, sending the data transmission request of the client to another server within a server cluster to which the server belongs.

5. The method of claim 4, wherein servers included in the server cluster are connected in a circulation structure.

6. The method of claim 1, wherein the calculating of the delay time for controlling the bandwidth of the client comprises calculating a shorter delay time as the priority of the data is higher.

7. The method of claim 1, wherein the calculating of the delay time for controlling the bandwidth of the client comprises calculating a shorter delay time as maximum throughput of the server is higher.

8. The method of claim 1, wherein the calculating of the delay time for controlling the bandwidth of the client comprises calculating a longer delay time as the number of clients connected to the server is larger.

9. The method of claim 1, wherein the calculating of the delay time for controlling the bandwidth of the client comprises calculating a longer delay time as the size of the chunks is larger.

10. The method of claim 1, wherein the receiving of the chunks of the data at intervals of the delay time comprises:
measuring throughput at a time when receiving the chunks from the client; and
correcting the delay time according to the measured throughput.

11. A method of controlling network interface, the method being performed by a server and comprising:
receiving a reception request for data from a client;
calculating a delay time for controlling bandwidth of the client; and
sending chunks of the data to the client at intervals of the delay time.

12. The method of claim 11, wherein the receiving of the reception request for the data comprises further receiving priority of the data from the client.

13. The method of claim 11, wherein the calculating of the delay time for controlling the bandwidth of the client comprises calculating a shorter delay time as the priority of the data is higher.

14. The method of claim 11, wherein the calculating of the delay time for controlling the bandwidth of the client comprises calculating a shorter delay time as maximum throughput of the server is higher.

15. The method of claim 11, wherein the calculating of the delay time for controlling the bandwidth of the client comprises calculating a longer delay time as the number of clients connected to the server is larger.

16. An apparatus for controlling network bandwidth, the apparatus comprising:
a network interface;
one or more processors;
a memory which loads a computer program executed by the processors; and
a storage device which stores throughput data and priority information,
wherein the computer program executed by the apparatus for controlling network bandwidth comprises:
an operation of receiving a transmission request for data from a client;
an operation of calculating a delay time for controlling bandwidth of the client;
an operation of receiving chunks of the data from the client at intervals of the delay time; and
an operation of restoring the data by merging the chunks.
